(19) United States
(12) Patent Application Publication
(10) Pub. No.: US 2007/0124493 A1
(43) Pub. Date: May 31, 2007

(54) System and Method for Ordering Content for User Review

(75) Inventor: Brian J. Fogg, Stanford, CA (US)

Correspondence Address: WONG, CABELLO, LUTSCH, RUTHERFORD & BRUCCULERI,;L.L.P., 20333 SH 249, SUITE 600, HOUSTON, TX, 77070, US

(73) Assignee: THE BOARD OF TRUSTEES OF THE LELAND STANFORD JR. UNIVERSITY, Palo Alto, CA (US)

(21) Appl. No.: 11/539,533

(22) Filed: Oct. 6, 2006

Related U.S. Application Data
(60) Provisional application No. 60/724,964, filed on Oct. 7, 2005.

(51) Int. Cl. G06F 15/16

(52) U.S. Cl. 709/231

(57) ABSTRACT

A system which seperates content into different streams, generally organized on a content subject matter basis. Inside each stream individual content items are ordered based on personal ordering criteria. The content item is analyzed and compared with the criteria to determine a predicted level of interest. A feedback process is preferred to develop the criteria. When a user is reviewing a content item, reviewing an entire item provides positive indications to various factors. To stop reviewing an item, the user can provide a termination indication, such as a JUMP key. Use of JUMP key provides negative indications for the various factors, with the timing scaling the negative indication, with a quicker indication having a higher negative value. These positive and negative indications are entered into a database to help update the personal ordering criteria. Existing entry values are modified and new entries are added with the indicated value.

### CROSS REFERENCE TO RELATED APPLICATION

This application claims the benefit of Provisional Patent Application Ser. No. 60/724,694, filed Oct. 7, 2005, entitled “System and Method for Ordering Content for User Review,” which is incorporated herein by reference.

### BACKGROUND OF THE INVENTION

1. FIELD OF THE INVENTION

The invention generally relates to devices and techniques for ordering content for review by a user.

2. DESCRIPTION OF THE RELATED ART

In modern society, we are inundated with information. There are conflicts between the large amount of information available, the desire to stay current, the ability to find the information, and the time available to review the information. To aid in finding information and staying current, Really Simple Syndication (RSS) has been developed. When used in conjunction with RSS reader software, information from the various selected RSS feeds is provided in a very timely manner to the user. Finding RSS feeds is becoming simpler everyday.

However, selecting which of this information should be read is still a problem, potentially ever larger than before with the proliferation of sources and reliabilities of the RSS feeds. And one thing that has increased dramatically is the amount of chaff that must be sorted through to find the wheat. Usually RSS readers and similar software track news feeds by their source and provide the content in reverse chronological order. While this provides some help, only rarely will a person want to read all of the content from a given source. Further, many sources provide content of different types and topic, many of which may not be desired.

Some RSS readers allow the ability to separate news feeds into categories. This is an improvement over mere separation by news feed, but only a slight improvement, as chaff is still present.

Therefore it would be desirable to provide techniques and systems which further organize content for easier, more time efficient assimilation by a user.

### SUMMARY OF THE INVENTION

A system according to the present invention separates content into different streams, generally organized on a subject matter basis. Inside each stream individual content items are ordered based on personal ordering criteria. The content item is analyzed and compared with the criteria to determine a predicted level of interest. This ordering is performed as each content item is received. This can often mean that content is not ordered in a chronological order but instead is provided in interest order. In this manner if the user only has a limited review time, the content of most interest can be reviewed first.

While the ordering criteria can be selected manually, a more efficient feedback process is preferred. When a user is reviewing a content item, the entire item can be reviewed, which provides positive indications to factors including the topic, the content source, the content author or poster, and the rankings for other users. To stop reviewing an item before its end, the user can provide a termination indication, such as a JUMP key, to cause the next item to be provided for review. Use of the JUMP key provides negative indications for the various factors. Preferably the timing of the JUMP indicator scales the negative indication, with a quicker indication having a higher negative value than a JUMP indication made after a longer period.

These positive and negative indications are entered into a database to help update the personal ordering criteria. Existing entry values for a given factor are modified and new entries are added with the indicated value. Over time the data accumulates and provides a very good predictor of the user's interest level in a particular content item. When entries are added or modified, the order of content items in each stream is reviewed and the order of the streams themselves is reviewed.

### BRIEF DESCRIPTION OF THE FIGURES

FIG. 1 is a block diagram of a system according to the present invention.

FIG. 2 is a representation of content streams with individual content items according to the present invention.

FIG. 3 is a drawing of an exemplary cell phone showing a content window and various other elements according to the present invention.

FIG. 4 is a block diagram of the software modules running on a backend system according to the present invention.

FIG. 5 is a block diagram of the software running on a mobile device according to the present invention.

FIG. 6 is a flowchart of content receipt operations in the backend system according to the present invention.

FIG. 7 is a flowchart of content review operations in the mobile device according to the present invention

FIG. 8 is a flowchart of feedback operations in the backend system according to the present invention.

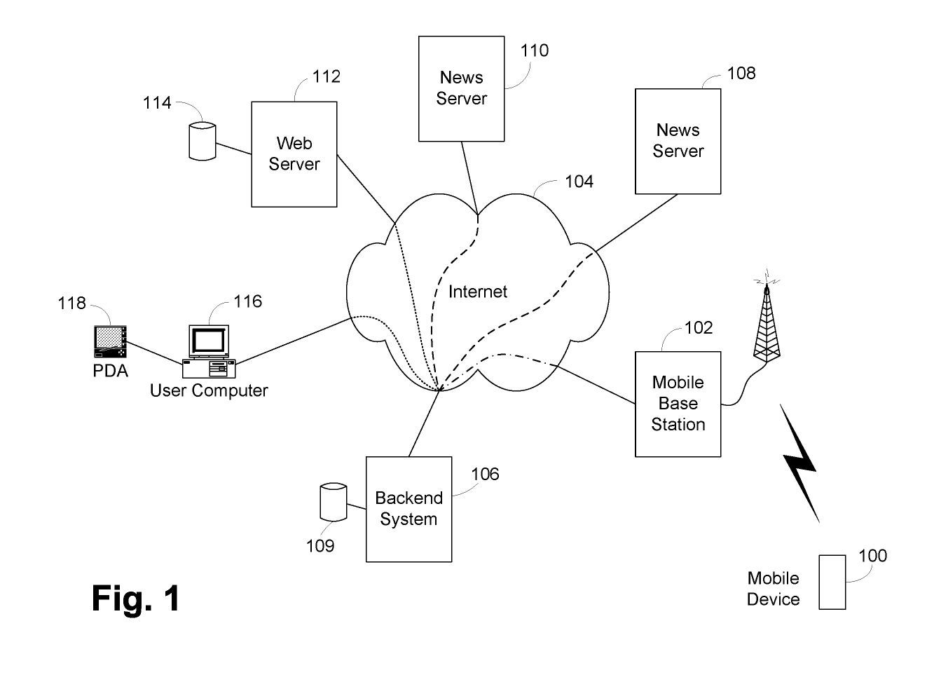

### DETAILED DESCRIPTION OF THE PREFERRED EMBODIMENT

A mobile device 100 is connected over a wireless link to a mobile base station 102. This mobile base station 102 is connected through the Internet 104 to a backend system 106. Preferably the communication between the backend system 106 and the mobile base station 104 is done in the form of e-mail, but other messaging techniques can be utilized. The backend system 106 preferably includes a database 109 to manage operations. The backend system 106 is further connected through the Internet 104 to news servers 108 and 11 0. Preferably the news servers 108 and 110 provide RSS feeds, but other techniques can be utilized if desired. A web server 112, with its associated storage 114, is also connected through the Internet 104 to the backend system 106. Finally, a user computer 116 and a connected PDA 118 are connected through the Internet 104 to the backend system 106. The user computer 116 can directly transfer files using standard IP protocols from the user computer 116 to the backend system 106 or through software running on the backend system 106, such as through a web server, can request and transfer files from the web server 112. Alternatively, the backend system 106 can provide the information to the user computer 116, which can locally store it on the PDA 1 18.

In operation, the new servers 108 and 110 provide news feeds to the backend system 106 and data files, preferably text files, are provided from the user computer 116 and the web server 112 to the backend system 106.

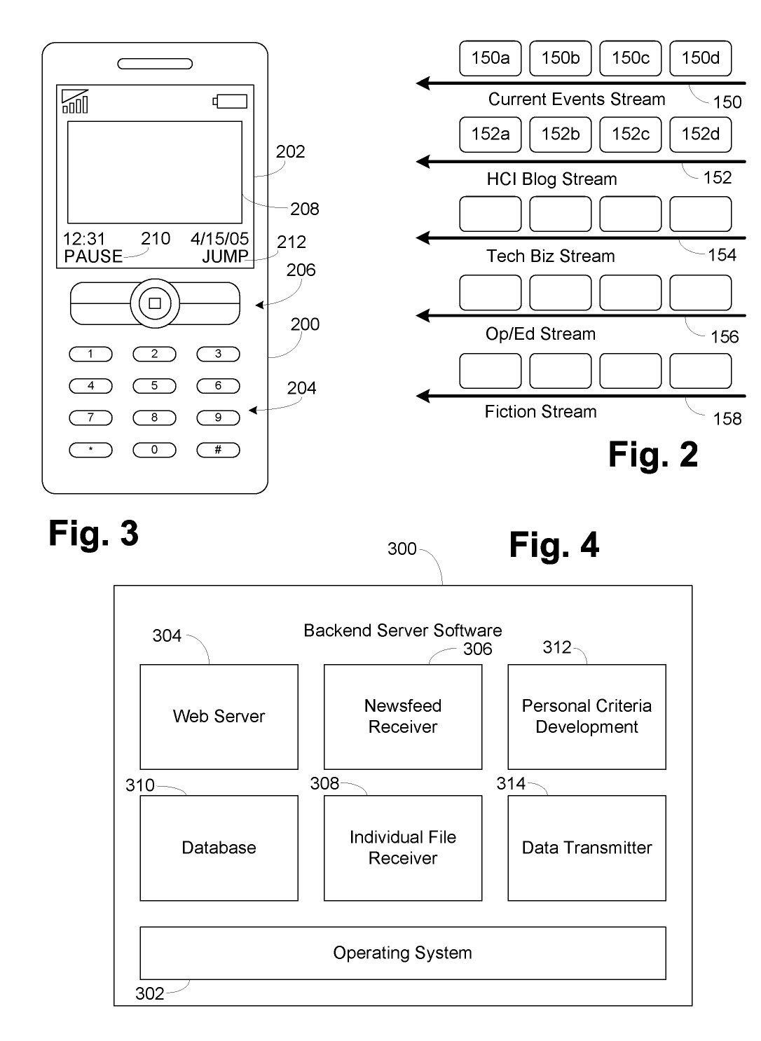

FIG. 2 illustrates the separation and ordering of content according to the preferred embodiment. As a first definitional point, particular content can be any form, such as text or HTML files, audio files, video files, image files, a combination of those or others. The user defines various streams or topic categories or may use predefined streams. These can be individual news sources but preferably are specific topics which can receive content from various sources, including news servers, web servers, individual files and so on. The use of specific topics is preferred because this allows further ease of use by allowing the various sources to be combined. FIG. 2 illustrates a current events stream 150, a human-computer interface (HCI) blog stream 152, a technology business (Tech Biz) stream 154, an opinion and editorial (Op/Ed) stream 156 and a fiction stream 158.

Each stream includes a series of individual content items. For example, the current events stream 150 includes items 150a to 150d while the HCI blog stream 152 includes items 152a to 152d. How the individual items are ordered depends on content. The backend system 106 will receive them in some chronological order, but the backend system 106 will provide them to the mobile device 100 in predicted interest order developed as discussed below. In certain embodiments the order of the streams represents the personal interest level in the stream as a whole.

FIG. 3 illustrates an exemplary cell phone 200 as the mobile device 100. The cell phone 200 includes a display area 202, a keypad area 204 and control buttons 206, with a control button potentially including a pointing device. In addition to the normal display areas for cell phone activity, such as the various menus in the corners, the day and date, signal strength and the battery capacity as shown in the display 202, a content display area 208 is provided for visual content. Additionally, two preferred soft buttons PAUSE 210 and JUMP 212 are illustrated, though hard or dedicated buttons could be provided if desired. The soft buttons are provided by providing text next to the relevant physical control button.

FIG. 4 is the block diagram on the software 300 running on the backend system 106. The various modules include an operating system 302, which can be any of the preferred operating systems; a web server 304 to provide an interface to a user computer such as user computer 116 or to the mobile device 100 to personalize the system or to provide management operations; a news feed receiver module 306 to interact with the news servers 108 and 110; and an individual file receiver module 308 to interact with the Web server 112 and the user computer 116 to receive individual text files indicated by the user. All of the information received by the receivers 306 and 308 is contained in a database 310. A personal criteria development module 312 receives initial information from the user and feedback information from the mobile device 100 to develop personal ordering criteria described more fully below. The database 310 contains the content items and the selection of streams and ordering of items in stream for each user. When content is to be transmitted to the mobile base station 102 or to the user computer 116, a data transmitter block 314 collects the file from the database 310 and transmits it to the base station 102 for transmission to the mobile device 100 or to the user computer 116.

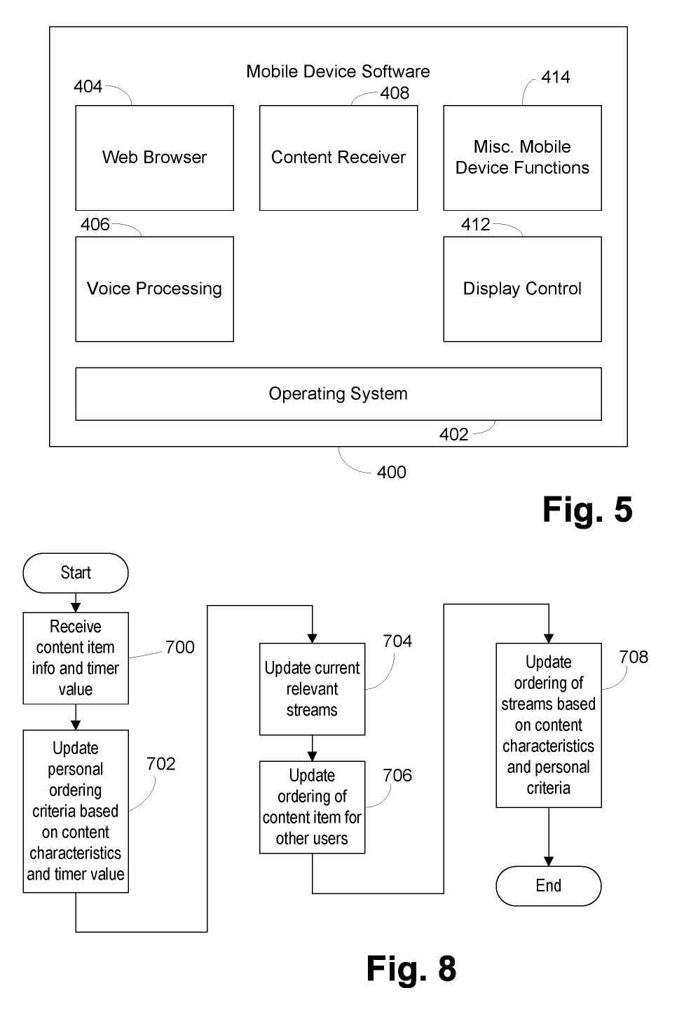

FIG. 5 is a block diagram of software 400 executing on the mobile device 100. An operating system 402 is, of course, present, as is a web browser 404, as in most cases these are more advanced mobile devices with web browsing capability, with one use of the web browser being to interface with the backend system 106 instead of the user computer 116. Because many of these are mobile phones, a voice processing module 406 is present. A content receiver module 408 receives the content items being provided from the mobile base station 102 or from the user computer 116 if the mobile device 100 is the PDA 118. These received content items, when appropriate, are provided to a content display control module 412, which takes the proper actions, such as displaying or playing the content and performing content feedback handling as described below. The display control module 412 also interacts with the various control buttons 206 to receive user inputs relating to the operations. Finally, a module 414 is present to perform the other miscellaneous mobile device functions necessary.

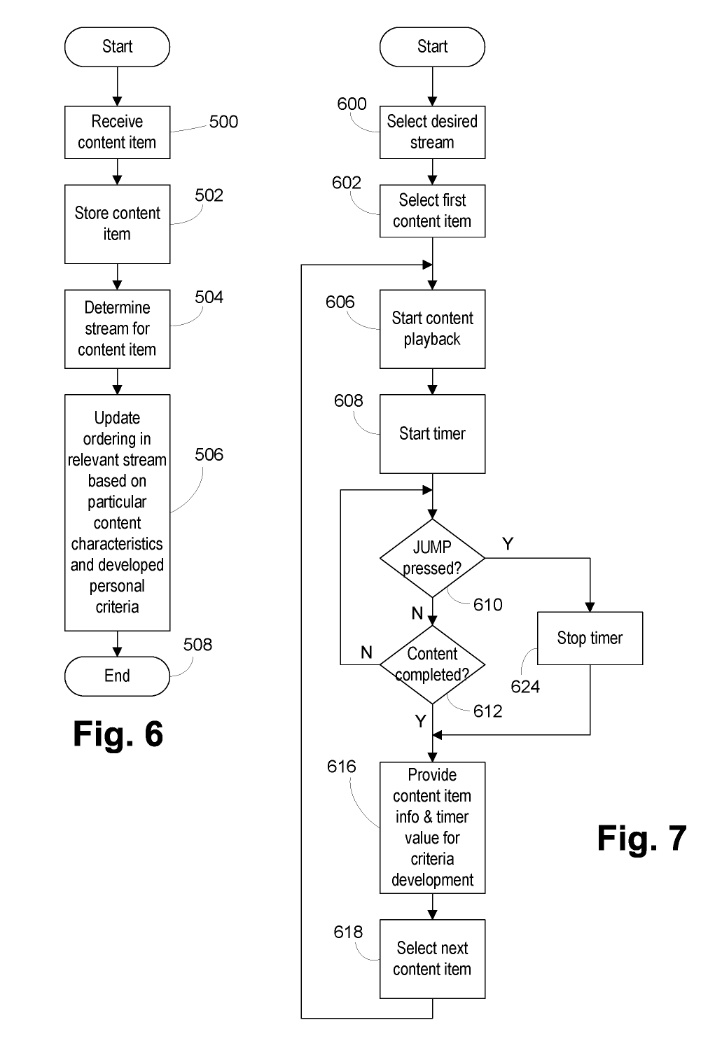

Referring now to FIG. 6, a simple flowchart for the backend system 106 is shown. At step 500 the backend system 106 receives a content item. In step 502 the backend system 106 stores the content item in database 310. In step 504 the content item is analyzed to determine the appropriate stream. In step 506 the ordering of the content items in the relevant stream is updated based on the content characteristics and personal ordering criteria so that the ordering is in predicted most interest order. Exemplary content characteristics include topic, content news source, content poster, content author, time and date of the content item and ranking of the item in streams of the user's indicated social network and from other users in general. It is also understood that the users in the indicated social network could vary between streams. Many other characteristics can be used if desired. The personal ordering criteria include weighting factors for both each characteristic and a particular value for each characteristic value. If no particular value exists, a default value is used. A ranking or rating value based on the weighting factors and the particular values is calculated. This can be as simple as multiplying each particular value by the weighting factor for that characteristic and then adding the results. Other techniques can be developed as desired. The ranking value for the content item is then compared to the ranking value for all other items in the appropriate stream and placed in the appropriate location in order. This sequence completes at step 508. It is understood that this is a very simple flowchart and in normal practice this would be done as a series of multitasking operations in the backend system 106.

FIG. 7 illustrates a simple flowchart of the operation of the mobile device 100. Operation begins at step 600 where the user selects the desired stream for content review. In step 602 the first content item for that stream is selected. In step 606 playback of the selected content item is started. In step 608 a timer is started. In step 610 it is determined whether a JUMP indication has been received from the user. If so, in step 624 the timer is stopped. If a JUMP indication has not been received, control proceeds to step 612 where a determination is made whether the playback of the content has completed. If not, control returns to step 610. If it has completed or after step 624, control proceeds to step 616 where the information identifying the content item and the timer value or completed indication are provided to the backend system 106 for personal ordering criteria development. In step 618 the next content item in order is selected and control returns to step 606 where the review of the next item starts automatically. Again, it is noted that this is a very simple flowchart for explanatory purposes and in actual operation this would be done using a series of multi-tasking threads and programs.

FIG. 8 illustrates a simple flowchart of the operation of the backend system 106 when feedback is received from the mobile device 100, such as from step 616. In step 700 the backend system 106 receives the content item identifying information and the timer value or completion indication. In step 702 the personal ordering criteria are updated using this received information. The characteristics of the content item are retrieved. As above, example characteristics are topic, content publisher, content poster, content author, content news source, and ranking of the content in streams of other users. Many other characteristics can be used if desired. The current value for each of these characteristics for the user is retrieved from the database 3 10. These values are then modified based on the JUMP timer value or completion of the content. Completion indicates the user reviewed the entire content of the item, a favorable indication. Therefore in cases of completion a positive or increasing factor is applied to the values. The factor can be a positive number added to the value or a value greater than one multiplied with the value. The actual amount of the favorable indication can be selected or preset and can be variable depending on the length of time required to review the full content.

If a JUMP indication was provided prior to completion, a negative or decreasing factor is applied to the values. Preferably this factor is inversely proportional to the timer value. Thus a very small timer value, indicating, for example, a JUMP after just reviewing the content title or headline, would have a greater effect on decreasing the particular content characteristics. A large timer value, say one minute, would have much less effect on decreasing the particular content characteristics because that time frame would indicate a large portion of the content may have been reviewed.

In cases of content with known playback times, such as audio or video items, the decrease may be based on the percentage of the item reviewed instead of the absolute time. Similarly, for textual entries, the length of the item could also be used to scale the time value and/or its effect. If used with an RSVP system as described, on U.S. patent application 60/625,493, entitled “System and Method for Providing Highly Readable Text on Small Mobile Devices” filed Nov. 5, 2004, which is hereby incorporated by reference, the timer value can be replaced with a percentage of content viewed as the RSVP control will know how much of the content has been displayed and how much remains. A further alternative for textual entries is determining if various sections have been reviewed, such as title, author, abstract, introduction, first paragraph, and the like. In this case the effects of the JUMP would preferably be non-linear, with just the title or author being more negative but if the abstract was reviewed, any negative factors would be appreciably smaller.

After these calculations and changes in the personal ordering criteria have been made, in step 704 the streams that contained content items whose characteristic values have been changed are updated. This may result in a stream being reordered, thus clearly showing the feedback operation. This may actually change the next content item selected in step 618 if the process of FIG. 8 occurs sufficiently quickly. In step 706 the value representing the ranking of the content item in other people's streams is changed based on the changed ranking of the content item. This may alter the order of the items in other parties' streams.

After completing changing the ranking of the content item for other users, in step 708 the ordering of the streams themselves is updated. The factors used to order the streams is slightly different than the ordering of content items within a stream. Factors can include how often content from the stream is reviewed, the average time the content items in the stream are reviewed, how the stream rates with both the user's social network and other users in general and a selectable bias or weighting factor. The bias factor would be used to keep streams more highly rated even though the other factors would tend to diminish the rating of the stream. An application would be a stream where the user is not particularly interested in the content but must keep current on it. While this updating is illustrated as being performed for each content item, it can be done less frequently if desired.

While this description has focused on having the backend system 106 separate from the mobile device 100, either as a standalone device or combined with the user computer 116, it is also understood that these functions could be performed in the mobile device 100, particularly in the future as processing and storage capabilities in the mobile device 100 increase.

While the primary mobile devices described above have been mobile phones and PDAs, it is understood that many other devices, such as electronic book readers, watches, pagers, radios, digital video recorders and the like, each potentially with their own communication network, can equally use the described techniques and thus are to be considered mobile devices. The PDA described above is one example of a wired device, but it is understood that other wired devices could also be used, including devices such as televisions which are not mobile.

While a mobile device 100 has been used as the exemplary device for user interaction, it is also understood that all of the functions can be performed on other devices, particularly notebook and desktop personal computers. In the case of personal computers, the backend system 106 functions can readily be combined with the mobile device 100 functions. Also in the case of personal computers the primary communication network would be a local area network (LAN) with gateways to the Internet as desired.

Operations on devices such as music players, satellite radio receivers and digital video recorders would be slightly different. Streams would be replaced by channels or similar groupings as the first difference. Second, the ordering rules and criteria development would be slightly altered because of the probability of repeating a content item. A user could include a factor or value indicating how frequently a content item could be repeated, either globally or on an individual basis. This value would be used to determine how far a particular content item moved in channel order after being reviewed.

While illustrative embodiments of the invention have been illustrated and described, it will be appreciated that various changes can be made therein without departing from the spirit and scope of the invention.

1. A method for providing content items to a user in an improved manner, the method comprising:
receiving a content item;
determining a stream appropriate for the content item;
analyzing the received content item and developing an ordering value based on characteristics of the content item; and
placing the received content item into the stream in ordering value sequence.

2. The method of claim 1, wherein the analyzing is performed based on personalized ordering criteria.

3. The method of claim 2, further comprising:
receiving an indicator of the amount of the content item reviewed by the user; and
utilizing the indicator to update the personalized ordering criteria.

4. The method of claim 3, wherein the indicator is a completion indicator or a value representing the choice of the user to stop reviewing the content item.

5. The method of claim 4, wherein a completion indicator provides a positive impact of the content item's characteristics in the personal ordering criteria.

6. The method of claim 5, wherein the value representing the choice to stop reviewing provides a negative impact of the content item's characteristics on the personal ordering criteria.

7. The method of claim 6, wherein the value is a length of time the content item was reviewed and wherein the amount of the negative impact is inversely proportional to the length of time.

8. The method of claim 4, wherein the value representing the choice to stop reviewing provides a negative impact of the content item's characteristics on the personal ordering criteria.

9. The method of claim 8, wherein the value is a length of time the content item was reviewed and wherein the amount of the negative impact is inversely proportional to the length of time.

10. The method of claim 3, further comprising:
updating the order of previously received content items for content items having characteristic values updated in the personalized ordering criteria.

11. The method of claim 10, wherein there are a plurality of streams which are presented in an order and further comprising:
updating the order of the plurality of streams based on the updated personal ordering criteria.

12. The method of claim 1, where the content of the content item is at least one of textual, audible or visual.

13. A system for providing content items to a user in an improved manner, the system comprising:
a communication interface;
a content item receiver;
file storage coupled to said content item receiver to store received content;
a content item stream determination module coupled to said file storage to determine a stream appropriate for a received content item;
a content item analyzer coupled to said file storage to analyze the received content item and develop an ordering value based on characteristics of the content item; and
a content item placement module to place the received content item into the determined stream in ordering value sequence.

14. The system of claim 13, wherein said content item analyzer is coupled to said file storage and utilizes a personalized ordering criteria stored in said file storage.

15. The system of claim 14, further comprising:
a personal ordering criteria update module coupled to said communication interface and said file storage to receive an indicator of the amount of the content item reviewed by the user and utilize the indicator to update the personalized ordering criteria.

16. The system of claim 15, wherein the indicator is a completion indicator or a value representing the choice of the user to stop reviewing the content item.

17. The system of claim 16, wherein said personal ordering criteria update module uses a complete indication to provide a positive impact of the content item's characteristics in the personal ordering criteria.

18. The system of claim 17, wherein said personal ordering criteria update module uses the value representing the choice to stop reviewing to provide a negative impact of the content item's characteristics on the personal ordering criteria.

19. The system of claim 18, wherein the value is a length of time the content item was reviewed and wherein the amount of the negative impact is inversely proportional to the length of time.

20. The system of claim 16, wherein said personal ordering criteria update module uses the value representing the choice to stop reviewing to provide a negative impact of the content item's characteristics on the personal ordering criteria.

21. The system of claim 20, wherein the value is a length of time the content item was reviewed and wherein the amount of the negative impact is inversely proportional to the length of time.

22. The system of claim 15, wherein said content item placement module updates the order of previously received content items for content items having characteristic values updated in the personalized ordering criteria by said personal ordering criteria update module.

23. The system of claim 22, wherein there are a plurality of streams which have an order and further comprising:
a stream order determination module coupled to said file storage to update the order of the plurality of streams based on the updated personal ordering criteria.

24. The system of claim 13, where the content of the content item is at least one of textual, audible or visual.

25. A system for providing content items to a user in an improved manner, the system comprising:
a user interface having a portion for providing content items for review by a user and having a user input indicator;
a content item player coupled to said user interface to play a content item for provision by said user interface;
a feedback analyzer coupled to said user input indicator and to said content item player to allow the user to provide feedback on the reviewed content item to indicate the amount of the content item reviewed; and
a transmitter for indication of the content item reviewed and an indicator of the amount of the content item reviewed.

26. The system of claim 25, wherein the indicator is a completion indicator or a value representing the choice of the user to stop reviewing the content item.

27. The system of claim 25, wherein the value is a length of time the content item was reviewed.
